(19) United States
(12) Patent Application Publication
(10) Pub. No.: US 2015/0200964 A1
(43) Pub. Date: Jul. 16, 2015

(54) METHOD AND APPARATUS FOR ADVANCED SECURITY OF AN EMBEDDED SYSTEM AND RECEPTACLE MEDIA

(71) Applicant: Alexander V. Kariman, Rockville, MD (US)

(72) Inventor: Alexander V Kariman, Rockville, MD (US)

(73) Assignee: SAFE FRONTIER LLC, McLean, VA (US)

(21) Appl. No.: 14/153,522

(22) Filed: Jan. 13, 2014

(51) Int. Cl. H04L 29/06

(52) U.S. Cl. CPC H04L 63/20; H04L 63/10

(57) ABSTRACT

The present disclosure provides a method and apparatus that facilitates remote monitoring and security of embedded systems, for example, receiving security related messages over the Internet and being able to respond to a security situation using an alternate interaction method and apparatus that allows to interact with the embedded system's modules, interfaces and attached devices regardless of the operating state of the primary security controls.

### FIELD OF THE INVENTION

The present invention generally relates to securing embedded systems, and particularly relates to monitoring and securing resource-constrained and full capability embedded devices and their receptacle media (embedded system, integrated system, and real-time system are used herein interchangeably). Such devices include but not limited to: industrial equipment, micro and macro embedded systems, intelligent meters, controllers, network gear, embedded automotive, marine, and aerospace systems, POS and retail equipment, ATM and banking, digital signage, entertainment systems, gaming systems, surveillance, infotainment, medical systems, critical embedded systems, household and office-use embedded systems, recreational and educational embedded systems, embedded systems equipped with a radio module, including cellular radio, embedded systems used in automation equipment, energy, mining, special and general purpose embed systems, and the like.

### BACKGROUND

Embedded systems play an increasingly important role in the human life and the economy. While the capabilities and uses vary widely, many embedded systems carry out important missions being out of a human sight. Embedded systems control machinery, operate on land, underground, in space, and in seas. Such systems are often deeply integrated into the equipment they control and oftentimes they are subjected to hostile and potentially insecure environments. Apparatuses controlled by embedded systems may also operate autonomously for a prolonged period of time and could be mobile—not having fixed geographical location. An example of such system could be a drone sea vessel, an underground intelligent metering system, or a mobile asset tracking system. Of course, there are redundant electronic circuits and security measures implemented to provide certain level of reliability and control. However, as there are more and more embedded systems being deployed, specifically, resource-constrained, mobile, and far removed systems, there is a need for more capable and less expensive solutions. Embedded systems are not servers being deployed primarily in the controlled environment of a datacenter. Nor they are user devices, e.g., they do not directly or at all interface a user. User today is the cornerstone of the computer security paradigm. Such devices oftentimes are monitored and controlled by other machines, where an administrator may only have an occasional physical access to the device. It is necessary not only to protect the electronics but also other critical system components. Taking security to the hardware level makes it much more difficult to circumvent. Embedded systems become more intelligent and many of them are now Internet-enabled. Just like other computing devices they need to be secured, monitored, and serviced. Administrators must have robust and convenient means to implement security policies, monitor devices, and be able to respond in case of an emergency. One of the factors limiting proliferation of the Internet-enabled embedded systems into the new use-arenas is the lack of cost-efficient, robust security controls to provide adequate security and emergency response services, especially when it comes to securing critical resource-constrained mobile systems.

One consequence of this inscrutability is that securing an embedded system oftentimes requires installing additional controls that are bulky, expensive, and often functionally limited. Conventional integrated security systems have a major drawback that if the embedded system is powered off or the operating system hung or crashed, the device becomes vulnerable. While some embedded devices provide additional controls for remote monitoring, it is oftentimes limited to a local network, provides rudimentary functionality, and generally does not provide monitoring and response capabilities if the main electronics, such as an operating system or a processor are off or not functioning properly.

A variety of network-enabled security systems with advanced capabilities are known. Most of them, however, primarily address user computing devices, servers, and security of corporate networks. For example, as described in the U.S. Pat. No. 8,286,002 B2 (Publication date Oct. 9, 2012), the invention provides an advanced security system enabling enterprise users to securely access an enterprise network while increasingly utilizing broadband wireless networks. Another invention, U.S. application Ser. No. 12/102,605 (Publication date Oct. 15, 2009) comprises of a system and a method for monitoring a baseboard management controller to determine from the data whether an unauthorized access has occurred. Another invention, U.S. Pat. No. 8,561,138 B2 (Publication date Oct. 15, 2013) describes a system and a method for providing added security to a platform using locality-based data. Another invention, U.S. Pat. No. 6,961,855 B1 (Publication date Nov. 1, 2005) describes a mechanism that informs enterprise authorities when security-sensitive decisions or actions have been or are attempting to be made; further, U.S. Pat. No. 5,945,915 A (Publication date Aug. 31, 1999) describes a computer system for sending an alert signal over a network when a cover of said system has been opened; and U.S. application Ser. No. 11/034,377 (Publication date Jul. 13, 2006) describes in essence a self-validation system using a dedicated validation circuit or process for verifying the computer is in compliance with a pre-determined set of conditions and imposing a sanction on the computer when the computer is found in a non-compliant state. Further, U.S. Pat. No. 8341729 B2 (Publication dated Dec. 25, 2012) describes a system and a method that may be used to implement policies for hardware access and monitoring control, as well as obtaining device property data from each device coupled to a system and determining if each device is a device authorized for use with the system. Another known apparatus, method, and platform U.S. Pat. No. 7,703,126 B2 (Publication dated Apr. 20, 2010) is designed for hierarchical trust-based posture reporting and policy enforcement for network access security. Another invention, PCT Application No. AU2000/001324 (Publication dated May 3, 2001) describes a vending machine security arrangement; and another known system, U.S. Pat. No. 7,171,467 B2 (Publication dated Jan. 30, 2007) provides out-of-band remote management station for authentication and authorization capabilities. Another invention, U.S. Pat. No. 7,853,682 B2 (Publication dated Dec. 14, 2010) describes a system and a method for consolidating, securing, and automating out-of-band access to nodes in a data network; further, U.S. Pat. No. 8,295,157 B1 (Publication dated Oct 23, 2012) describes a system and a method for using out-of-band protocols for remote management while in-band communication is not available; and another invention U.S. Pat. No. 5,764,886 A (Publication dated Jun. 9, 1998) describes in-band/out-of-band alert delivery system operated in a local area network, a wide area network, and en enterprise network environments.

The threat landscape for modern Internet-enabled embedded systems is in many ways different from the threat landscape of personal computers and servers. Not only that embedded systems have their own set of operating constraints, such as oftentimes being operated by other machines and not directly by users, potential security problems do arise across specific domains of use, particularly with the new use-models. This invention is aiming to incorporate security into the design of an embedded system at a fundamental level. The described prior art is limited in addressing the needs of the modern-day Internet-enabled embedded systems, especially when it comes to the resource constraints and use-models of the new generation devices. Such constraints include: network bandwidth, device size, power supply limitations, processing power, cost constraints, etc. Other considerations are mobility, autonomous operation, multitude of service providers and data consumers, very large number of devices, large volume of generated data, etc.

### DESCRIPTION OF THE INVENTION

The present invention provides an improved method and apparatus for securing and monitoring embedded systems. According to an aspect of the present invention, there is a method and apparatus for remotely monitoring and securing an embedded system that includes among other components: an operating system responsible for operating the embedded system (in-band operating system); an independent program of instructions or an operating system (out-of-band operating system) that works independent of the embedded system's operating system. It also includes a security engine or the steps of providing a security engine for the embedded system. Such engine includes at least one procedure for monitoring and/or securing the embedded system, and/or altering security configuration of the embedded system, and/or harvesting data related to the embedded system. There is also network access software that is independent of the in-band operating system that can access a website via the Internet to exchange data with the website related to the procedure, where such data can be accessed by an application and/or personnel. For the purpose of illustrating this invention, terms “embedded system” and “embedded device” may be used interchangeably and both mean to include the receptacle media; and term “security” and its derivative terms shall mean security in the broadest possible meaning, e.g., anything that relates to safe and reliable operation of the embedded system and its receptacle media and connected devices and networks.

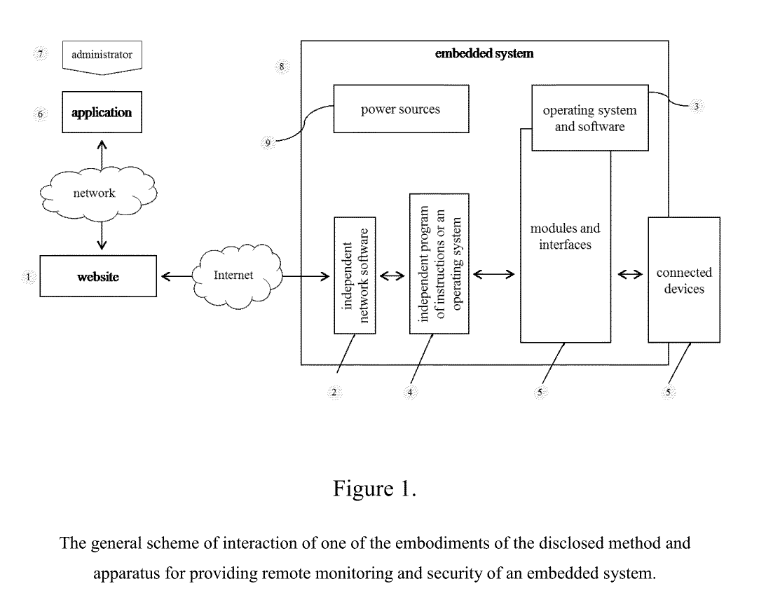

FIG. 1 illustrates an exemplary embodiment of the method and apparatus that facilitates monitoring and security of an embedded system. A website 1 interacts with the independent network software 2 that is separate from the embedded system's operating system 3. Such independent network software 2 interacts with the program of instructions or an operating system 4 that is separate from the operating system 3 that operates the embedded system 8. Such independent program of instructions or an operating system 4 interacts with the embedded system's internal modules, interfaces, and devices connected to the embedded system 5. The independent program of instructions or an operating system 4 executes security procedures and transmits data regarding the procedures to the independent network software 2. The independent network software 2 transmits over the Internet the aforementioned data to the website 1, where an application 6 and an administrator 7 can access and process such data automatically or manually. An administrator 7 interacts with the embedded system 8 and its relevant sensors, modules, interfaces, and connected devices 5 via the independent program of instructions or the operating system 4, next, via the independent network software 2, the website 1, and the application 6. In some descriptions of the exemplary embodiments and illustrations, terms “administrator” 7 and “application” 6 could mean the same termination point and therefore could be used interchangeably.

FIG. 1 further illustrates an exemplary embodiment of the apparatus that facilitates remote monitoring and security of an embedded system, where in one embodiment such apparatus may have the independent network software 2 and/or the independent program of instructions or the operating system 4 that is separate from the operating system 3 that operates the embedded system 8, being integrated into the embedded system's electronic circuitry and/or silicon. In one embodiment of such apparatus, the processor that operates the independent network software 2 and/or the independent program of instructions or the operating system 4 is powered by the same power sources that may power the embedded system 9. For the purpose of describing this invention, the “power source” means: an electrical battery, power grid, solar, piezo, wind, or chemically generated electrical power, or any other power source.

FIG. 1 further illustrates an exemplary embodiment of the apparatus where the independent program of instructions or the operating system 4 can interact with the embedded system's sensors, modules, interfaces, and connected devices 5, including the interfaces of the operating system 3 that operates the embedded system 8 and the software that is executed in such operating system 3.

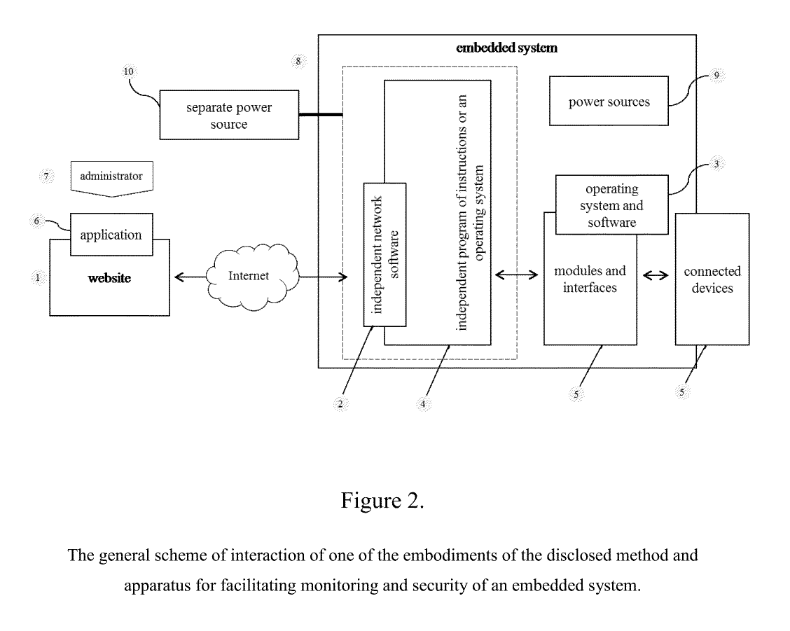

FIG. 2 illustrates an exemplary embodiment of the disclosed method and apparatus where the independent network software 2 is a part of the independent program of instructions 4 or being executed by the operating system 4 that is separate from the operating system that operates the embedded system 3.

FIG. 2 further illustrates an exemplary embodiment of the disclosed method and apparatus where the website 1 and the security application 6 are operably coupled.

FIG. 2 further illustrates an exemplary embodiment of the disclosed method and apparatus where the processor that operates the independent network software 2 and/or the independent program of instructions or the operating system 4 is powered from a separate power source 10 than the embedded system.

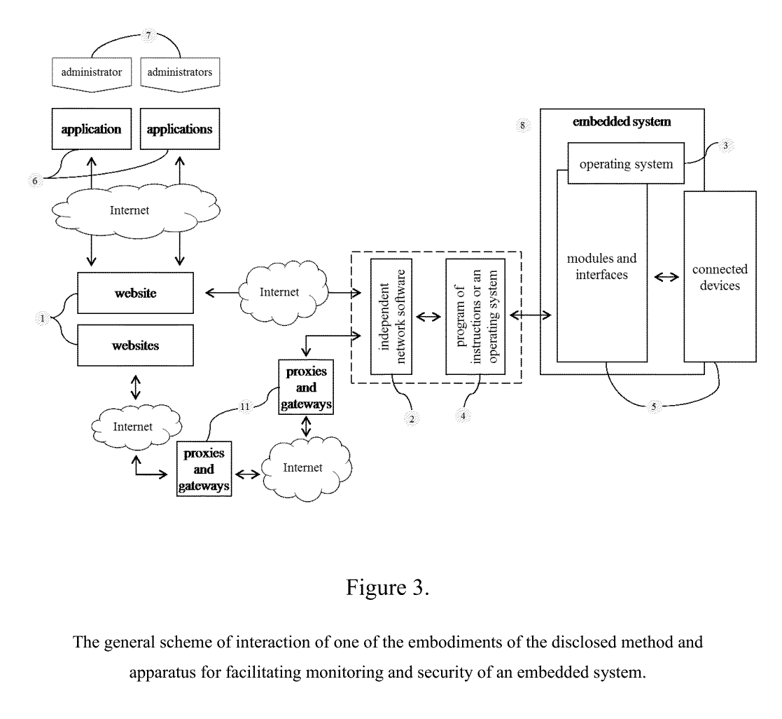

FIG. 3 illustrates an exemplary embodiment of the disclosed method and apparatus where the independent network software 2 may connect consecutively or concurrently and exchange data with plurality of websites 1. In some embodiment, the plurality of applications 6 may connect and exchange data with the website 1. In some embodiment, the access of applications 6 to the website 1 can be accessed controlled. In other embodiment, the plurality of administrators 7 may interact with the application 6.

FIG. 3 illustrates an exemplary embodiment of the disclosed method and apparatus where the independent network software 2 may connect to the website 1 via any number of physical and/or logical intermediaries of various types, such as proxies and/or gateways 11, including: web proxies, caching proxies, translation proxies, encryption proxies, filtering proxies, transparent proxies, DNS proxies, home gateways, Internet gateways, industrial gateways, VPN gateways, office gateways, cellular gateways, wireless gateways, modems, repeaters, signal extenders, routers, switches, firewalls, peered network-enabled computing devices, and the like.

FIG. 3 further illustrates an exemplary embodiment of the disclosed apparatus, where the independent network software 2 and/or the independent program of instructions or the operating system 4 that is separate from the operating system 3 that operates the embedded system 8, being communicatively coupled with the interfaces of the embedded system in a way that makes possible to operate independently of the embedded system's operating system 3, and not being a part of the electronic circuitry of the embedded system 8. Therefore it is possible to disengage and/or remove the media carrying independent network software 2 and/or the independent program of instructions or the operating system 4 from the embedded system 8.

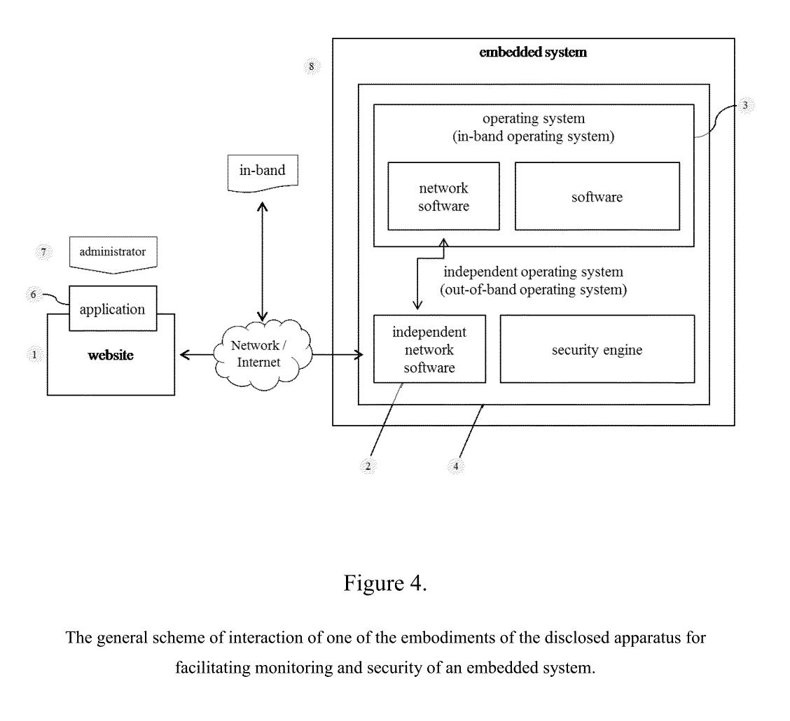

FIG. 4 illustrates an exemplary embodiment of the disclosed apparatus, where the independent operating system 4 hosts the virtualized operating system 3 that operates the embedded system.

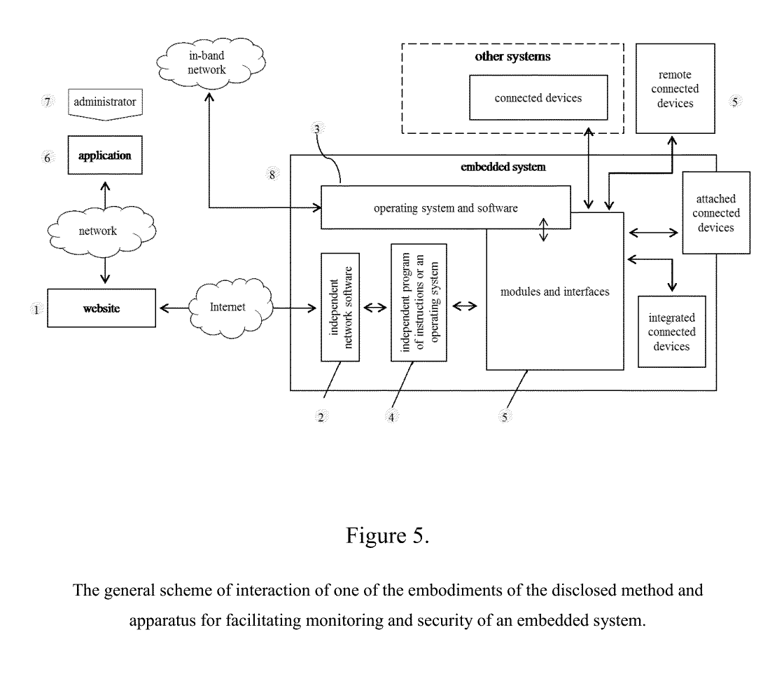

FIG. 5 illustrates an exemplary embodiment of the disclosed apparatus, where the apparatus has operably and/or communicatively coupled plurality of sensors, modules, and connected devices 5 located at various sites. Such sensors, modules, and connected devices 5 interact with the operating system that operates the embedded system 3, and/or they interact with the independent program of instructions or the operating system 4.

In one exemplary embodiment, a security program running on an embedded system independent of the embedded system's operating system performs security related interaction between the embedded system and a remote security application via the Internet. The security program executing on the embedded system allows security posture monitoring and security event generation, as well as information exchange between the remote security application and the embedded system, regardless of the state of the embedded system's operating system. Further, in at least some exemplary embodiment, the method and apparatus may support two-way interaction between a remote application and an embedded system, where the application may receive an alert from the embedded system or a security code message and the application may activate certain logic and respond automatically by transmitting any number of command instructions and parameters to the embedded system.

In another exemplary embodiment, the disclosed method and apparatus may support interaction between a remote administrator and an embedded system where the application can automatically receive or security administrator can manually request by sending a command to the embedded system, information about geographical location of the embedded system, such as GPS produced location data, or location data produced by a cellular, Wi-Fi, or plurality of other apparatuses of various types capable of producing location data or metadata. Application may then store this data, process this data, visualize this data on the map, or compare this data against preset action triggers, such as geo-fencing. Such data can also be used, for example, to locate a stolen or a missing asset, or provide out-of-band geo-tracking of a mobile asset, or may be used for any other purpose.

In another exemplary embodiment, the disclosed method and apparatus may support interaction between a remote administrator and an embedded system where the administrator exchanges security and management related data with the embedded system's internal modules, interfaces, and connected devices. Terms “devices” and “modules” may be used interchangeably and represent electronic articles operably and/or communicatively coupled with the embedded system, such as, but not limited to environmental sensors, surveillance sensors, geo-positioning sensors, gyroscopic sensors, motion sensors, radiofrequency sensors, tampering detection sensors, video and audio sensors, biometrical scanners, and any other sensors and scanners, video, audio, network cards, radio modules, including cellular radio, attached or internal data storage media, displays, controls, actuators, user authentication devices, surveillance devices, peripheral devices, and other modules and devices. Such devices may also be located in the silicon, integrated into the electronic circuitry, enclosed in or located on the embedded system's receptacle media, or be located outside of the embedded system's receptacle media, or be connected using a network interface or a bus, etc.; for example: be a part of the chip, system on the chip, chipset, locate on the electronic circuit board, inside the electronic circuit board container, or on the outside of the container, or at large, e.g. being located anywhere else, or being coupled in various ways with other systems but being at minimum communicatively coupled with the described embedded system. The receptacle media means the article of manufacture that is coupled with the embedded system; for example, an automobile being the receptacle media, and the infotainment system electronic processing unit being the embedded system.

In another exemplary embodiment, the disclosed method and apparatus may support interaction between a security administrator and an embedded system where the administrator receives security and management related data from the embedded system's volatile and/or non-volatile memory, for example to receive a virus signature or operating system's crash dump, log file, or a memory image, or other security relevant information, and may respond by sending data to be written into the volatile and/or non-volatile memory of the embedded system.

In another exemplary embodiment, the disclosed method and apparatus may support interaction between a remote administrator and an embedded system where the administrator can receive and inject data packets from/into the communication traffic between the embedded system's operating system and the communication buses and networks it interfaces.

In another exemplary embodiment, the disclosed method and apparatus may support interaction between a remote administrator and an embedded system where the administrator may receive data packets of the security related video and audio data traffic between the embedded system's operating system and audio/video devices it interfaces; and if necessary, remotely transmit data to such video and audio devices; for example, to provide a video/audio warning.

In another exemplary embodiment, the disclosed method and apparatus may support automated and manual interaction between a remote administrator and an embedded system where the administrator can receive data, send commands, and otherwise interact with the embedded system's hardware, firmware, and software regardless of the operating state of the embedded system's operating system and in-band processors.

In another exemplary embodiment, the disclosed method and apparatus may support interaction between a remote administrator and an embedded system where the administrator can carry out security related incident remediation services on the embedded system, which may include a malware scan, replacement of software and/or firmware of the embedded system, including the software and/or firmware of the independent program of instructions or an operating system and/or the independent network access software, including providing patches and updates.

In another exemplary embodiment, the disclosed method and apparatus may support interaction between plurality of independent remote administrators using independent applications and a single embedded system; as such, plurality of separate service organizations may interact with the embedded system to provide security services in their respective domains.

In another exemplary embodiment, the disclosed method and apparatus may support interaction between a remote security administrator and an embedded system using a point to point network tunnel, where the administrator can interact with the embedded system over the Internet using security and management tools, in the essence comparable, as if the embedded system was communicating with the tools, as if it was operating in a local network with said tools. For example, an administrator can access WMI service or other security relevant embedded system's local services and interfaces.

In another exemplary embodiment, the disclosed method and apparatus may support interaction between a remote security administrator and an embedded system where the administrator can authenticate an embedded system independently of the embedded system's operating system, using the independent program of instructions or an operating system and independent network access software. In some embodiment, such authentication may also involve exchanging information with the operating system that operates the embedded system. In another embodiment, such authentication may also involve the security application comparing authentication data received from the independent network software and the operating system that operates the embedded system.

In another exemplary embodiment, the disclosed method and apparatus may support interaction between a remote administrator and an embedded system where the administrator can interact with the embedded system to control its functional features as to execute a security task; for example, when an administrator deactivates a component of the embedded system in order to perform incident remediation, or protect the embedded system or the network it is coupled with.

In another exemplary embodiment, the disclosed method and apparatus may support interaction between a remote administrator and an embedded system where the embedded system is equipped with plurality of tampering sensors, and upon a trigger, such as an attempt to open a protective casing, the apparatus transmits an alert to the administrator, as described in the disclosed invention. In some embodiment, the tampering sensor may be located in the electronic circuitry of the embedded system or integrated into the silicon. In another embodiment, the sensor may be located in a separate article of manufacture but be communicatively coupled with the embedded system.

In another exemplary embodiment, the disclosed method and apparatus may support interaction between a remote administrator and an embedded system where the embedded system is equipped with software that monitors tampering with the embedded system's software and/or firmware. An example of such software can be a host based intrusion prevention system. Upon a trigger, the system transmits an alert to the administrator, as described in the disclosed invention.

In another exemplary embodiment, the disclosed method and apparatus may provide out-of-band detection of authorized dismantlement, for example, a transaction machine. A remote security administer will receive an alert once the transaction machine is opened by a service technician and can execute certain procedures to make sure that the servicing is performed safely. For example, administrator may be alerted if the service is taking too long, indicative of possible security issue, or the dismantlement may automatically trigger a surveillance system, etc.

In another exemplary embodiment, the disclosed method and apparatus may provide out-of-band detection of intrusion into a vehicle. A remote administrator will receive an alert once the intrusion detection sensor on the vehicle is triggered. In another embodiment, the disclosed apparatus may be integrated into a vehicle's electronic circuit but may operate using an alternative power source and have an independent network card where the alert can be transmitted even when the vehicle's electronic systems are off or electrical power is disconnected.

In another exemplary embodiment, the disclosed method and apparatus may provide an out-of-band detection of a vehicle collision. A remote administrator will receive an alert once the accelerometer sensor detects a possible collision. In another embodiment, multiple disclosed apparatuses may be integrated into vehicle's multiple electronic circuits, and in some cases they may operate from alternative power sources, and have independent network cards, where the alert can be transmitted event when the vehicle's electronic systems are not functioning. Another example is transmitting environmental data, such as air temperature or presence of gasoline fumes, indicative of possible fire or fire hazard.

In another exemplary embodiment, the disclosed method and apparatus may provide an out-of-band detection of tampering with a driver alcohol level metering system installed in a vehicle. A remote administrator will receive an alert once the apparatus detects tampering via a sensor located in the metering system. In another embodiment, the disclosed apparatus may be integrated into vehicle's central computing systems, and in some cases it may interact with such computing system, as for example, to disable the vehicle upon a command from the administrator. The apparatus may afterwards transmit a message to the administrator that the vehicle is disabled.

In another exemplary embodiment, the disclosed method and apparatus may support interaction between a remote administrator and an embedded system, detecting when certain sensors, modules, interfaces, and devices are removed or decoupled from an embedded system. Upon detecting an event or via some other logic, the system may transmit an alert to the administrator, as described in the disclosed invention. For example, an alert may be triggered if one of the sensors is decoupled from the embedded system or a communication interface was removed or attempted to be removed.

In another exemplary embodiment, the disclosed method and apparatus may support interaction between a remote administrator and an embedded system, where the administrator can establish secure or unsecure network tunnel over the Internet from the application to the independent network software of the embedded system to provide security management or incident remediation services. In one embodiment, independent network software may initiate communication with the website and then the independent network software and the website establish a network tunnel. In one embodiment, such network tunnel may encapsulate plurality of network protocols. In another embodiment, such network tunnel may be used by administrator to interact with plurality of devices communicatively coupled with the embedded system. In another embodiment, such network tunnel can be created or terminated upon a certain triggering event on the embedded system, on schedule, or it may exist continuously and/or persistently. In another embodiment, the embedded system may be acting as a server after such network tunnel was established, and the application may interact with the security engine as if it was a server and the application is a client.

In another exemplary embodiment, the disclosed method and apparatus may support interaction between the website and an embedded system, where the independent network software interacts with the website using a protocol capable of multiple recipient, multicast, broadcast addressing, for example MQTT. In another embodiment, such protocol may be used for basic messaging and a network tunnel, using a tunneling protocol, such as VPN, can be established concurrently or consecutively to other communications upon a certain message trigger. In another embodiment, such network tunnel may be established upon receiving a signal from the embedded system's operating system using embedded system's communication interfaces. In another embodiment, such network tunnel may be established upon the independent network software receiving an SMS message or a push message. In another embodiment, security procedure may be initiated upon receiving an SMS message or a push message. In another embodiment, security procedure may be initiated upon a certain triggering event on the embedded system, on schedule, or it may execute continuously and/or persistently.

Of course, many exemplary variations may be practiced with regard to establishing such interaction. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents. method and apparatus for advanced security of an embedded system and receptacle media

What claimed is:

1. A method of securing embedded systems, having:
at least one processor that operates the embedded system (in-band processor); and
a communications interface operably coupled with the processor that operates the embedded system; and
at least one program of instructions or an operating system for operating the embedded system (in-band operating system), and
an independent program of instructions or an operating system (out-of-band operating system), which includes security engine or the steps of providing a security engine for the embedded system, which includes at least one procedure for monitoring and/or securing the embedded system, and/or generating at least one security related alert, and/or altering security configuration of the embedded system, and/or harvesting data related to the embedded system; and
network access software, which accesses the Internet from the embedded system, and operates independently of the in-band operating system, and uses said Internet access to access at least one website over the Internet, exchanging data with at least one website related to the procedure, where such data could be accessed by an application and/or personnel.

2. A method according to claim 1, wherein the website is accessed via at least one proxy and/or gateway.

3. A method according to claim 1, wherein the website is accessed via at least one peered network-enabled computing device.

4. A method according to claim 1, wherein the website is accessed when the processor that operates the embedded system and/or out-of-band operating system is switched off, not fully operable, or malfunctions.

5. A method according to claim 1, wherein the independent network access software accesses more than one website.

6. A method according to claim 1, wherein the independent network access software transmits an identifier for identifying an Internet location where the results of the procedure are located.

7. A method according to claim 1, wherein a website includes at least one of: a computing device, a data storage medium, a web server, an email server, a file server, an application server, a message gateway, a proxy gateway, a server that stores the results of the procedure in a database, a database.

8. A method according to claim 1, wherein the independent Internet access software includes at least one of: a LAN driver, a WAN driver, a WWAN driver, a TCP/IP stack, an HTTP stack, a UDP stack, network security software.

9. A method according to claim 1, wherein the independent Internet access software provides access by at least one of: HTTP, FTP, TELNET, SOCKS, VNC, OMA DM, TLS, SSL, WS-Management, SNMP, VPN, SMS, MMS, Common Industrial Protocol, Modbus, Ethernet/IP, PROFIBUS, PROFINET, DeviceNet, CAN, protocols capable of at least one: multiple recipient, multicast, broadcast addressing, tunneling protocols, pear to pear communication protocols.

10. A method according to claim 1, wherein the independent Internet access software communicates with at least one website Out of Band (OOB).

11. A method according to claim 1, wherein the independent Internet access software uses one of: DHCP and static IP.

12. A method according to claim 1, wherein the method includes a step of transmitting embedded system's security and/or management data to at least one website.

13. A method according to claim 1, wherein the method includes a step that allows at least one website to uniquely identify the embedded system.

14. A method according to claim 1, wherein the method includes a step of transmitting to at least one website data or metadata that can be used to determine geographical location of the embedded system.

15. A method according to claim 1, wherein the method includes a step of transmitting to at least one website data or metadata from a geo-positioning system communicatively and/or operably coupled with the embedded system.

16. A method according to claim 1, wherein the method includes a step of transmitting to at least one website data from at least one device communicatively and/or operably coupled with the embedded system.

17. A method according to claim 1, wherein the method includes a step of transmitting data to at least one website related to tampering with the embedded system's software, and/or hardware, and/or firmware, and/or network, and/or the receptacle media, and/or at least one device connected to the embedded system.

18. A method according to claim 1, wherein the method includes a step of transmitting information to at least one website regarding coupling or decoupling of at least one device and/or interface to/from the embedded system.

19. A method according to claim 1, wherein the method includes a step of transmitting data to at least one website that allows authenticating the embedded system.

20. A method according to claim 1, wherein the method includes a step of transmitting to at least one website the data related to embedded system's security posture.

21. A method according to claim 1, wherein the method includes a step of transmitting data about at least one security and/or management related event to the website.

22. A method according to claim 1, wherein the method includes a step of exchanging data between at least one embedded system's module, interface, and/or connected to the embedded system device and at least one website.

23. A method according to claim 1, wherein the independent program of instructions or an operating system (out-of-band operating system), and/or security engine is provided from one or more of: a boot disc, a hidden partition in a hard disc drive of the embedded system, volatile, and non-volatile data storage media, a remote network location, a USB device.

24. A method according to claim 1, wherein the independent program of instructions or operating system (out-of-band operating system) is executed by at least one service processor (out-of-band processor) communicatively and/or operably coupled with the embedded system.

25. A method according to claim 1, wherein the independent program of instructions or operating system (out-of-band operating system) is executed by at least one processor (in-band processor).

26. A method according to claim 1, wherein the personnel is one of a user or an owner of the embedded system.

27. An method according to claim 1, wherein at least one in-band operating system works in the virtualization environment where the host is the out-of-band operating system.

28. An apparatus for securing embedded systems, having:
at least one processor that operates the embedded system (in-band processor); and
a communications interface operably coupled with the processor that operates the embedded system; and
at least one program of instructions or an operating system for operating the embedded system (in-band operating system), and
an independent program of instructions or an operating system (out-of-band operating system), which includes security engine or the steps of providing a security engine for the embedded system, which includes at least one procedure for monitoring and/or securing the embedded system, and/or generating at least one security related alert, and/or altering security configuration of the embedded system, and/or harvesting data related to the embedded system; and
network access software, which accesses the Internet from the embedded system, and operates independently of the in-band operating system, and uses said Internet access to access at least one website over the Internet, exchanging data with at least one website related to the procedure, where such data could be accessed by an application and/or personnel.

29. An apparatus according to claim 28, wherein a website includes at least one of: a computing device, a data storage media, a web server, an email server, a file server, an application server, a message gateway, a proxy gateway, a server that stores the results of the procedure in a database, a database.

30. An apparatus according to claim 28, wherein the independent Internet access software includes at least one of: a LAN driver, a WAN driver, a WWAN driver, a TCP/IP stack, an HTTP stack, a UDP stack, and network security software.

31. An apparatus according to claim 28, wherein the independent Internet access software provides access by at least one of: HTTP, FTP, TELNET, SOCKS, VNC, OMA DM, TLS, SSL, WS-Management, SNMP, VPN, SMS, MMS, Common Industrial Protocol, Modbus, Ethernet/IP, PROFIBUS, PROFINET, DeviceNet, CAN, protocols capable of at least one: multiple recipient, multicast, broadcast addressing, tunneling protocols, and pear to pear communication protocols.

32. An apparatus according to claim 28, wherein the independent Internet access software is capable of communicating with at least one website using Out of Band (OOB) communication channel.

33. An apparatus according to claim 28, wherein the independent Internet access software uses one of DHCP and static IP.

34. An apparatus according to claim 28, wherein at least one of: the diagnostic and/or data harvesting engine is capable of generating, and the independent network access software is capable of transmitting the embedded system's configuration and/or security data to at least one website.

35. An apparatus according to claim 28, wherein the independent network access software allows at least one website to uniquely identify the embedded system.

36. An apparatus according to claim 28, wherein the independent network access software transmits to at least one website data or metadata that can be used to determine geographical location of the embedded system.

37. An apparatus according to claim 28, wherein the independent network software transmits to at least one website data or metadata from a geo-positioning system communicatively and/or operably coupled with the embedded system.

38. An apparatus according to claim 28, wherein the independent network software transmits to at least one website data from at least one device communicatively and/or operably coupled with the embedded system.

39. An apparatus according to claim 28, wherein the independent network software transmits data to at least one website related to tampering with the embedded system's software, and/or hardware, and/or firmware, and/or network, and/or the receptacle media, and/or at least one device communicatively and/or operably coupled with the embedded system.

40. An apparatus according to claim 28, wherein the independent network software transmits information to at least one website related to coupling or decoupling of at least one device and/or interface to/from the embedded system.

41. An apparatus according to claim 28, wherein the independent network software transmits data to at least one website that allows authenticating the embedded system.

42. An apparatus according to claim 28, wherein the independent network software transmits to at least one website data related to embedded system's security posture.

43. An apparatus according to claim 28, wherein the independent network software transmits data about at least one security and/or management related event to at least one website.

44. An apparatus according to claim 28, wherein the independent Internet access software is capable of exchanging data with at least one of: the embedded system's modules, interfaces, and connected to the embedded system devices, and at least one website.

45. An apparatus according to claim 28, wherein the independent program of instructions or the operating system (out-of-band operating system) is capable of exchanging data with at least one operating system (in-band operating system) that operates the embedded system and/or software that is executed in the operating system that operates the embedded system (in-band operating system).

46. An apparatus according to claim 28, wherein the independent program of instructions or an operating system (out-of-band operating system), and/or security engine is provided from one or more of: a boot disc, a hidden partition in a hard disc drive of the embedded system, volatile, and non-volatile storage media, a remote network location, a USB device.

47. An apparatus according to claim 28, wherein at least one of: the security engine is capable of operating, and the independent network access software is capable of communicating with at least one website when at least one processor (in-band processor) that operates the embedded system, and/or at least one operating system that operates the embedded system (in-band operating system) is switched off, not fully operable, or malfunctions.

48. An apparatus according to claim 28, wherein the security engine exchanges data with at least one Baseboard Management Controller (BMC), and/or at least one System Management Module (SMM), and/or at least one Trusted Platform Module (TPM), and/or at least one protected memory coupled with the embedded system.

49. An apparatus according to claim 28, wherein the independent program of instructions or operating system (out-of-band operating system) is executed by at least one service processor (out-of-band processor) coupled with the embedded system.

50. An apparatus according to claim 28, wherein the independent program of instructions or operating system (out-of-band operating system) is executed by at least one processor (in-band processor).

51. An apparatus according to claim 28, wherein the security engine may store data in volatile and/or nonvolatile memory communicatively and/or operably coupled with the embedded system.

52. An apparatus according to claim 28, wherein at least one in-band operating system works in the virtualization environment where the host is the out-of-band operating system.
